(19) United States
(12) Patent Application Publication
(10) Pub. No.: US 2015/0236805 A1
(43) Pub. Date: Aug. 20, 2015

(54) METHODS, A BROADCAST MANAGEMENT UNIT AND A USER EQUIPMENT FOR HANDLING DIGITAL CONTENT IN A CELLULAR COMMUNICATIONS NETWORK

(71) Applicant: TELEFONAKTIEBOLAGET L M ERICSSON (publ), Stockholm (SE)

(72) Inventors: Chris Mcevilly, Bagshot (GB); Daniel Molander, Bromma (SE)

(73) Assignee: Telefonaktiebolaget L M Ericsson (publ), Stockholm (SE)

(21) Appl. No.: 14/433,795

(22) PCT Filed: Nov. 2, 2012
(86) PCT No.: PCT/EP2012/071710

§ 371 Date: Apr. 6, 2015

(51) Int. Cl. H04H 20/72; H04W 4/12; H04W 4/08; H04W 72/04; H04W 48/04

(52) U.S. Cl. CPC H04H 20/72; H04W 72/04; H04W 48/04; H04W 4/08; H04W 4/12

(57) ABSTRACT

Providing digital content to at least one user equipment At least one user equipment is served by a base station in a cellular communications network. A broadcast management unit obtains information identifying the digital content and a presentation area associated with the digital content. The broadcast management unit provides, based on the obtained information, a broadcast or multicast of the digital content in a service area. The service area comprises the presentation area and the at least one user equipment. The at least one user equipment is thereby enabled to, via the base station, receive the digital content in the service area and to visually and/or audially present the digital content in response to that the at least one user equipment has determined that the at least one user equipment is located in the presentation area.

### TECHNICAL FIELD

Embodiments herein relate to a method in a broadcast management unit, a broadcast management unit, a method in a user equipment and a user equipment. In particular embodiments herein relate to providing digital content to a user equipment in a cellular communications network.

### BACKGROUND

Communication devices such as User Equipments (UEs) are also known as e.g. mobile terminals, wireless terminals and/or mobile stations. A user equipment is enabled to communicate wirelessly in a cellular communications network, wireless communications network, wireless communications system, or radio communications system, sometimes also referred to as a cellular radio system or cellular network. The communication may be performed e.g. between two user equipments, between a user equipment and a regular telephone and/or between a user equipment and a server via a Radio Access Network (RAN) and possibly one or more core networks, comprised within the cellular communications network.

The user equipment may further be referred to as a mobile telephone, cellular telephone, smart phone, laptop, Personal Digital Assistant (PDA), tablet computer, surf plate, just to mention some further examples. The user equipment in the present context may be, for example, portable, pocket-storable, hand-held, computer-comprised, or vehicle-mounted mobile device, enabled to communicate voice and/or data, via the RAN, with another entity, such as another user equipment or a server.

The cellular communications network covers a geographical area which is divided into cell areas, wherein each cell area being served by a base station, e.g. a Radio Base Station (RBS), which sometimes may be referred to as e.g. “eNB”, “eNodeB”, “NodeB”, “B node”, or BTS (Base Transceiver Station), depending on the technology and terminology used. The base stations may be of different classes such as e.g. macro eNodeB, home eNodeB or pica base station, based on transmission power and thereby also cell size. A cell is the geographical area where radio coverage is provided by the base station at a base station site. By the base station serving a cell is meant that the radio coverage is provided such that one or more user equipments located in the geographical area where the radio coverage is provided may be served by the base station. One base station may serve one or several cells. Further, each base station may support one or several communication technologies. The base stations communicate over the air interface operating on radio frequencies with the user equipment within range of the base stations.

In some RANs, several base stations may be connected, e.g. by landlines or microwave, to a radio network controller, e.g. a Radio Network Controller (RNC) in Universal Mobile Telecommunications System (UMTS), and/or to each other. The radio network controller, also sometimes termed a Base Station Controller (BSC) e.g. in GSM, may supervise and coordinate various activities of the plural base stations connected thereto. GSM is an abbreviation for Global System for Mobile Communications (originally: Groupe Spécial Mobile).

In 3rd Generation Partnership Project (3GPP) Long Term Evolution (LTE), base stations, which may be referred to as eNodeBs or eNBs, may be directly connected to one or more core networks.

UMTS is a third generation mobile communication system, which evolved from the GSM, and is intended to provide improved mobile communication services based on Wideband Code Division Multiple Access (WCDMA) access technology. UMTS Terrestrial Radio Access Network (UTRAN) is essentially a radio access network using wideband code division multiple access for user equipments. The 3GPP has undertaken to evolve further the UTRAN and GSM based radio access network technologies, for example into evolved UTRAN (E-UTRAN) used in LTE.

In the context of this disclosure, the expression downlink (DL) is used for the transmission path from the base station to the user equipment. The expression uplink (UL) is used for the transmission path in the opposite direction i.e. from the user equipment to the base station.

In a cellular communications network various services are provided, via base stations to user equipments being served in the cells thereof, such as voice communication services and data services available on or via the Internet, or other local data networks. The data services may be services available on the World Wide Web (WWW), typically accessible to a user equipment via a web browser application installed thereon, or data services that are available via other protocols and/or relevant only to more specific applications or software installed on the user equipment. Using such data services involves download of digital content to the user equipment. Certain parts of the cellular communications network are responsible for identifying user equipments that request such data services and then makes sure that the service is provided to the user equipment via the base station serving the user equipment. This is preferably provided in such way that the user of the user equipment does not experience any negative impact from the fact that the service is provided via the cellular communications network. For example, a user that uses an application executing on a user equipment, e.g. a web browser, for accessing digital content on the Internet, simply wants the access without having to care of, or be negatively affected, by the fact that the connection is via the cellular communications network.

However, there are certain problems associated with the desire to provide such user experience. One problem is the fact the there is a limited bandwidth in each cell and thereby restrictions in how many user equipments that may be guaranteed a certain quality of service at the same time. By a continuously increasing number of user equipments and increasing usage of data services in cellular communications networks of today, the problem is becoming increasingly greater. Even if the overall capacity is increased there will still be a certain maximal amount of bandwidth available in each cell for the delivery of digital content for the data services, and there may be usage peaks where it would be desirable to provide digital content to user equipments in a cell at such amount and rate that would exceed the capacity of the cell. When this happens the result is a poor user experience, e.g. bad performance of the data service, errors in the digital content and/or data service, or even non-access to the requested digital content or non-availability of the data service,

### SUMMARY

An object of embodiments herein is to provide a way of improving the performance in a cellular communications network.

According to a first aspect of embodiments herein, the object is achieved by a method in a broadcast management unit for providing a digital content to at least one user equipment being served by a base station in a cellular communications network. The broadcast management unit obtains information identifying the digital content and a presentation area associated with the digital content. The broadcast management unit provides, based on the obtained information, a broadcast or multicast of the digital content in a service area. The service area comprises the presentation area and the at least one user equipment. The at least one user equipment is thereby enabled to, via the base station, receive the digital content in the service area and to visually and/or audially present the digital content in response to that the at least one user equipment has determined that the at least one user equipment is located in the presentation area.

According to a second aspect of embodiments herein, the object is achieved by a method in a user equipment for receiving a digital content. The user equipment is served by a base station in a cellular communications network. The user equipment identifies that the digital content is available from a broadcast or multicast in a service area and is associated with a presentation area. The service area comprises the presentation area and the user equipment. The user equipment receives the digital content by broadcast or multicast from the base station. The user equipment is thereby enabled to visually and/or audially present the digital content in response to that the user equipment has determined that the user equipment is located in the presentation area.

According to a third aspect of embodiments herein, the object is achieved by a broadcast management unit for providing a digital content to at least one user equipment served by a base station in a cellular communications network. The broadcast management unit comprises an obtaining circuitry, configured to obtain information identifying the digital content and a presentation area associated with the digital content. The broadcast management unit further comprises a providing circuitry, configured to, based on the obtained information, provide a broadcast or multicast of the digital content in a service area. The service area comprises the presentation area and the at least one user equipment. The at least one user equipment is thereby enabled to, via the base station, receive the digital content in the service area and to visually and/or audially present the digital content in response to that the at least one user equipment has determined that the at least one user equipment is located in the presentation area.

According to a fourth aspect of embodiments herein, the object is achieved by a user equipment for receiving a digital content. The user equipment is configured to be served by a base station in a cellular communications network. The user equipment comprises an identifying circuitry, configured to identify that the digital content is available from a broadcast or multicast in a service area and is associated with a presentation area. The service area comprises the presentation area and the user equipment. The user equipment further comprises a receiving port, configured to receive the digital content by broadcast or multicast from the base station. The user equipment is thereby enabled to visually and/or audially present the digital content in response to that the user equipment has determined that the user equipment is located in the presentation area.

As should be realized, by providing broadcast or multicast of a digital content instead of providing unicast of the digital content, it is enabled sending and addressing of one and the same copy of the digital content to the at least one user equipment, i.e. multiple user equipments, at the same time. This instead of sending and addressing a separate copy of the digital content to each one of the multiple user equipments as in the case of unicast that is conventionally used by base stations for delivery of digital content to user equipments in cellular communications networks. Thus multiple unicast downlink transmissions, one for each one of the multiple user equipments, where each unicast transmission requires a certain bandwidth, are possible to replace by the provided broadcast or multicast with a bandwidth that is independent on the number of receiving user equipments.

Hence, by providing digital content by broadcast or multicast in the service area comprising the presentation area and for visual and/or audial presentation by the user equipment when the user equipment is located in the presentation area, according to the above aspects of embodiments herein, digital content for informing about e.g. a specific location comprised in the presentation area may be provided to and be visually and/or audially presented by the user equipment and multiple other user equipments when they are located in the presentation area. This can be accomplished cost efficiently and with very efficient utilization of cell capacity per user equipment. To the cost of cell capacity corresponding to what a single user equipment would require if the digital content would be provided by unicast, the embodiments herein enable respective user equipment being served in the service area to receive the digital content and to visually and/or audially present it when the respective user equipment is located in the presentation area. This also enables a new type of location specific services that may be provided in the cellular communications network and that involves digital content that is location specific for visual and/or audial presentation by user equipments in the presentation area. Such services may, owing to the efficient use of cell capacity per user, be provided with very low or no charging at all for the services at the user equipment end. However, revenues may instead be enabled from e.g. the providers and/or producers of the digital content, e.g. store keepers or companies behind stores, or any one that may be interested in to be able to locally deliver and present local specific digital content to a large number of users via their respective user equipment. At the same time, if the result is that user equipments focus on services based on digital content available from broadcast or multicast, this reduce the unicast load on cells in the cellular communications network and thereby reduce the risk of cell capacity overload.

Further advantages for example include:

User equipments receiving digital content by broadcast or multicast instead of by unicast enable reduced signaling and less resources may need to be allocated. For example, in LTE, less resource blocks, which may be a limited resource, may need to be allocated.

### BRIEF DESCRIPTION OF THE DRAWINGS

Examples of embodiments herein are described in more detail with reference to the appended schematic drawings, in which:

FIG. 1 is a schematic block diagram depicting an example of a cellular communications network.

FIG. 2 is a schematic block diagram depicting another view of the example in FIG. 1.

FIG. 3 is a combined signalling diagram and flowchart for illustrating examples of embodiments herein.

FIG. 4 is another combined signalling diagram and flowchart for illustrating examples of embodiments herein.

FIG. 5 is a flow chart illustrating a method in a broadcast management unit according to embodiments herein.

FIG. 6 is a schematic block diagram illustrating a broadcast management unit according to embodiments herein.

FIG. 7 is a flow chart illustrating a method in a user equipment according to embodiments herein.

FIG. 8 is a schematic block diagram illustrating a user equipment according to embodiments herein.

FIG. 9 is a schematic block diagram depicting a simplified example of the cellular communications network.

### DESCRIPTION

Multimedia Broadcast Multicast Services (MBMS) is a point-to-multipoint interface specification for existing and upcoming 3GPP cellular networks, which is designed to provide efficient delivery of broadcast and multicast services. See for example:

ETSI TS 123 246 V9.6.0 (2012 January): Universal Mobile Telecommunications System (UMTS); LTE; Multimedia Broadcast/Multicast Service (MBMS); Architecture and functional description (3GPP TS 23.246 version 9.6.0 Release 9),

ETSI TS 125 346 V9.1.0 (2010 April): Universal Mobile Telecommunications System (UMTS); Introduction of the Multimedia Broadcast/Multicast Service (MBMS) in the Radio Access Network (RAN); Stage 2 (3GPP TS 25.346 version 9.1.0 Release 9), and

ETSI TS 136 300 V9.9.0 (2012 January): LTE; Evolved Universal Terrestrial Radio Access (E-UTRA) and Evolved Universal Terrestrial Radio Access Network (E-UTRAN); Overall description; Stage 2 (3GPP TS 36.300 version 9.9.0 Release 9), Section 15 MBMS.

MBMS for LTE may generally be referred to as evolved MBMS (eMBMS). The embodiments herein are compatible with and may preferably be implemented in a cellular communications network, in particular LTE-based, that support MBMS, i.e. eMBMS. This should be appreciated by the skilled person from the examples that will follow.

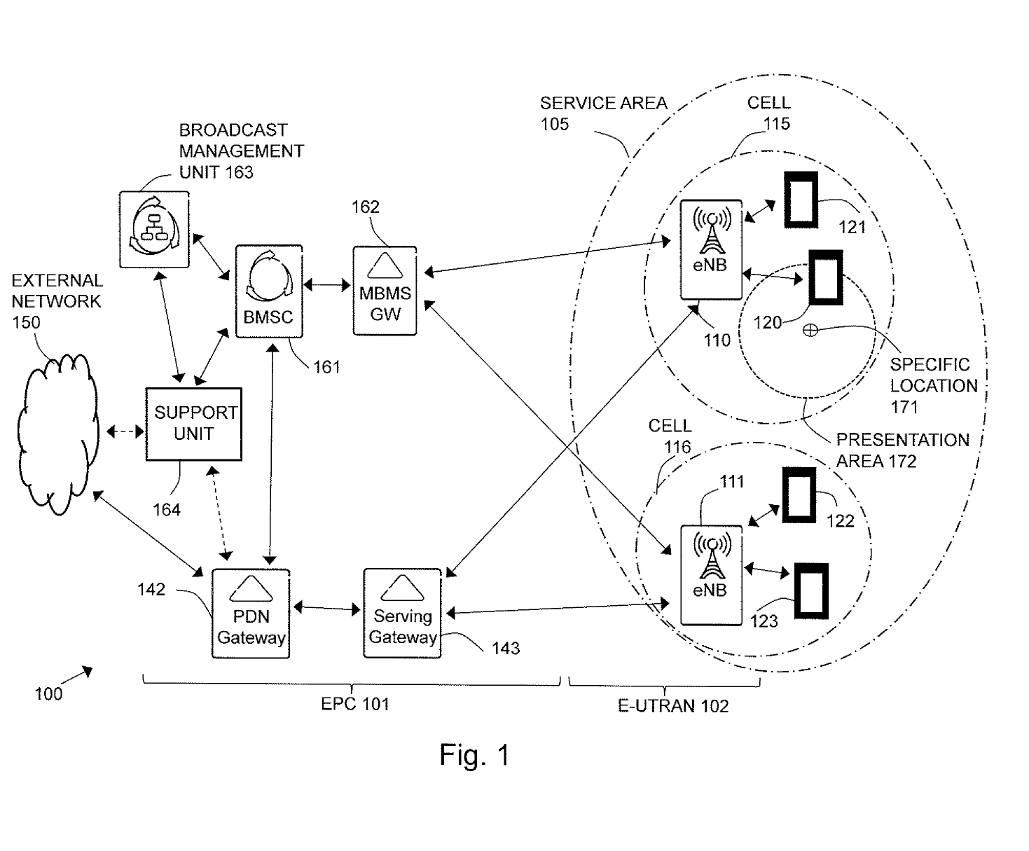

FIG. 1 is a schematic block diagram depicting an example of a cellular communications network 100. In the shown example the cellular communications network 100 corresponds to an LTE based cellular communications network, as should be recognized by the skilled person. As indicated in the figure, the network 100 comprises an Evolved Packet Core (EPC) network 101, being example of a core network, and an Evolved UMTS Terrestrial Radio Access Network (E-UTRAN) 102, being example of a RAN.

The shown cellular communications network 100 further comprises a base station 110 serving a cell 115 and a base station 111 serving a cell 116. The base stations 110, 111 are named eNB in the figure, which is the common denomination used for a base station in LTE-based networks.

Located and served in cell 115 is a first user equipment 120 and a second user equipment 121 and located and served in cell 116 is a third user equipment 122 and a fourth user equipment 123. The enumerated naming is only for exemplary reasons and in the following the user equipments 121-123 may be referred to as additional or other user equipments. Both the cell 115 and the cell 116 are located in a service area 105. The service area 105 may be defined by the cells that it comprises or may defined by a geographical area and thereby will comprise cells in the same geographical area. The service area 105 will be further discussed below.

The shown arrows in FIG. 1 indicate paths for communication of user plane data, such as communication of digital content that may result when the user equipments 120, 121, 122, 123, are utilizing data services provided in the cellular communications network 100 for accessing one or more digital contents.

By a digital content is herein meant a digital content that is provided by one or more services available to user equipments, e.g. the first user equipment 120, in the cellular communications network 100. The digital content may corresponds to such digital content available on the Internet, e.g. available on the World Wide Web (WWW), often referred to as web content, but may also be other kind of digital content. For example, the digital content may relate to a web radio transmission for reception by an application running on the user equipment, a video clip for view on the user equipment, a web-page for execution and display using a web-browser executing on the user equipment, and/or the digital content may be application specific digital content, just to mention some examples. The digital content may correspond to a single data file or a group of data files. The digital content may be live and/or streamed digital content.

Still referring to FIG. 1, the cellular communications network 100 further comprises a Packet Data Network (PDN) Gateway 142 and a Serving Gateway 143, as known from LTE. The PDN Gateway 142 is an example of an interface between an internal IP network of the operator of the cellular communications network 100 and an external network 150. The external network 150 may e.g. be the Internet or a Local Area network (LAN). In LTE, the Serving Gateway 143 has a main task of tunnelling user plane data between the PDN Gateway 142 and the base stations 110, 111. The PDN Gateway 142 and the Serving Gateway 143 are logical units in LTE, which logical units may be implemented in the same physical unit, but more typically in separate physical units and as separate network nodes in the cellular communications network 100, in particular in the EPC network 101 thereof.

The shown cellular communications network 100 also comprises a MBMS GateWay (MBMS GW) 162 and a Broadcast Multicast Service Center (BMSC) 161. The general role, task and interrelations of the MBMS GW 162 and a BMSC 161 may be in accordance with the above mentioned 3GPP specifications relating to MBMS for LTE, i.e eMBMS. Hence, the MBMS GW 162 may i.a. provide functionality for sending of MBMS packets comprising the digital content to the base stations 110, 111 for broadcast or multicast in the cells 115, 116. The MBMS GW 162 may use IP multicast as a means for forwarding MBMS user plane data, such as the digital content in the MBMS packets, to the base stations 110, 111. Note that this may be the case even though the digital content is being provided by broadcast in the respective cells. The BMSC 161 may i.a. be responsible for delivering user plane data, such as the digital content, to the MBMS GW 162. The BMSC 161 may also provide a number of service layer function such as Forward Error Correction (FEC) and file Repair in order to ensure Quality of Service (QoS) in delivery of the digital content to the user equipments 120, 121, 122, 123. Also, Service Announcements of what is available by broadcast or multicast to the user equipments 120, 121, 122, 123, such as the first user equipment 120, may be provided as a service layer function by the BMSC 161.

The shown cellular communications network 100 also comprises a broadcast management unit 163 for providing the digital content to the user equipments 120, 121, 122, 123, by e.g. controlling the BMSC 161, directly, via and/or with support from one or more support units 164 that will be further discussed below. The broadcast management unit 163 may e.g. be involved in and/or responsible for deciding what digital content to provide and when and where it shall be provided for the broadcast or multicast. Or in other words, the broadcast management unit 163 may be involved in and/or responsible for providing, planning and scheduling the provision the digital content for the broadcast or multicast. The broadcast management unit 163 may also be involved in and/or responsible for monitoring tasks, archiving tasks, and/or provide support to various organizations, typically within or connected to the operators of the cellular communications network 100, such as to network operations, service operations, customer care and also co-operating organizations, e.g. service providers of digital content. The broadcast management unit 163 will be further discussed below. The MBMS GW 162 and the BMSC 161 are logical units, which may be implemented in a respective corresponding physical unit or units, or together with other logical units or functionality in one or more shared physical units. Furthermore, the MBMS GW 162 and the BMSC 161 typically represent separate network nodes in the cellular communications network 100, more particularly in the EPC network 101 thereof. The broadcast management unit 163 is a logical unit that may be implemented in a corresponding physical unit or units, or together with other logical units or functionality in one or more shared physical units. The broadcast management unit 163 may, but not necessary, correspond to a network node in the cellular communications network 100, such as in the EPC 163 in case of an LTE based cellular communications network 100.

As illustrated in FIG. 1, the cellular communications network 100 may further comprise one or more support units 164 that may be communicatively connected to the BMSC 161, the broadcast management unit 163 and/or to each other. The one or more support units 164 may e.g. comprise a content providing unit and/or a data carousel providing unit and/or a scheduling unit. The content providing unit may e.g. provide digital content from one or more sources to the BMSC 161 and/or to the data carousel providing unit. Digital content and examples thereof are discussed in some detail below. One source may be the external network 150, e.g. the Internet, from which the digital content may be retrieved via the PDN Gateway 142 or via some other connection. Another source may be digital content provided by e.g. a producer of the digital content exclusively for the broadcast or multicast and for the user equipment 120 to visually and/or audially present the digital content when the user equipment 120 is in a presentation area, as will be described below. Yet another source may be one or more encoders or re-encoders for content that is relevant to transform before being subject to broadcast or multicast, e.g. analogue content and/or content in an inappropriate digital format. For example, digital content produced for another kind of system, e.g. television, such as video content from television satellites may be inappropriate to use directly in a network based on LTE and eMBMS. The content providing unit may further comprise and/or be configured to retrieve digital content from one or more storages in the cellular communications network 100, typically in the EPC network 101. The one or more storages may be comprised in the content providing unit. Some or all of the one or more storages may be in a physical unit that corresponds to the content providing unit, and/or some or all of the one or more storages may be in one or more physical units that are separate from a physical unit comprising the content providing unit. Digital content that has been stored in and is available from the one or more storages in the cellular communications network 100 enable a faster response to a decision to provide the digital content by broadcast or multicast and may also guarantee availability and quality of the digital content to be used for the broadcast or multicast. In some embodiments, one or more such storages may be connected to the PDN Gateway 142 and the BMSC 161 and be configured, e.g. via the PDN Gateway 142, to store digital content that is a candidate to be recommended and to be provided by the broadcast or multicast. The broadcast management unit 163 may be responsible for configuring what and when to store something in the one or more storages.

Still referring to FIG. 1 and the one or more support units 164. The scheduling unit that may be comprised in the one or more support units 164 may e.g. provide information about when to start and/or stop and/or change the broadcast or multicast, e.g. when to add or remove the digital content from the broadcast or multicast. The data carousel providing unit that may be comprised in the one or more support units 164 may e.g. provide a data carousel where digital content that has been retrieved for the broadcast or multicast is inserted. By broadcast of the data carousel, the digital content will repeatedly occur in the broadcast or multicast. As should be understood, a data carousel is mainly relevant for digital content corresponding to data files but typically not for streaming data. For example, by providing a file of digital content in a data carousel, the file of digital content is made more suitable for continuous broadcast or multicast and to be provided by broadcast or multicast at the same time together with other digital content. The other digital content may be comprised in the same or another data carousel, or may be such that is already provided as a data stream, e.g. a web radio transmission. The scheduling unit may operate directly on the data carousel providing unit so that a data carousel comprising properly scheduled digital content may be provided to the BMSC 161. By digital content comprised in a data carousel may be referred to data format and or structure where one or more copies of the digital content may be interleaved with other data and where the format and/or structure is for sending in a repeating pattern. Sending of the data carousel may thus result in repeated sending of the digital content, corresponding to a data stream where copies of the digital content repeatedly will occur.

In some embodiments, one or more support units 164 may be a respective logical unit that may be implemented in one and the same physical unit as e.g. the BMSC 161 or the broadcast management unit 163. In some embodiments, one or more support units 164 may be a respective logical unit that corresponds to a separate physical unit.

As shown in FIG. 1, the service area 105 comprises a presentation area 172 associated with a digital content. The presentation area is an area for visual and/or audial presentation of the digital content by user equipments, e.g. the user equipments 120-123 when these are located in the presentation area 172. The presentation area 172 corresponds to a geographical area. The presentation area 172 may comprise a specific location 171. For example, the specific location may be a store in a shopping area and the presentation area 172 may correspond to the shopping area, or the presentation area 172 may correspond to a smaller neighborhood area in the vicinity of the store. As mentioned above, the digital content may be provided by the producer of the digital content via the content providing unit of the one or more support units 164 and/or via the external network 50. The producer may in such case e.g. be a keeper of the store and/or a company behind the store.

In the context of embodiments herein, the digital content associated with the presentation area 172 is typically, fully or partly, specifically produced for visual and/or audial presentation by user equipments, e.g. one or more of the user equipments 120-123, when these are located, i.e. comprised, in the presentation area 172.

The digital content associated with the presentation area 172 advantageously comprises information informing about the presentation area 172 and/or the specific location 171 comprised therein. Such digital content may be referred to as location specific digital content. By visually and/or audially presenting the digital content, the information comprised therein become visually and/or audially presented and thereby a user of the user equipment that is carrying out the presentation may be directly and conveniently informed about the presentation area 172 and/or the specific location 171 comprised therein.

Further, in the context of embodiments herein, the digital content typically comprises information for visual and/or audial presentation by the first user equipment 120, or by user equipments in general, including e.g. user equipments 120-123, when respective user equipment has determined that it is located in the presentation area 172, which will be further discussed below.

By visual presentation of the digital content by a user equipment, e.g. any one of user equipments 120-123, is typically meant that the digital content is displayed on a display of the user equipment, e.g. when the digital content comprises text, graphics or video. By audial presentation of the digital content by a user equipment, e.g. any one of user equipments 120-123, is typically meant that the digital content is played through a loudspeaker of, or headset connected to, the user equipment.

In some embodiments, the presentation area 172 may correspond to an area of radio coverage provided by one or more cells, e.g. cells 115, 116, having said one or more identities. However, it may be advantageous with a presentation area, such as the presentation area 172, that does not correspond to, or at least is not defined dependent on cell areas. For embodiments herein it is instead typically advantageous with a presentation area, such as the presentation area 172, that is defined, and may be identified, independent of the one or more cells areas that it may fully or partly cover, and thus that the presentation area 172 need not to correspond to one or more cell areas. One reason is that any change regarding cells, e.g. any one of cells 115, 116, in the service area 105, e.g. in order to increase capacity, else would result in that the presentation area 172 would change, e.g. disappear, move, expand or shrink, as well. Another reason is that independence of cell areas provides greater freedom in defining the presentation area 172 and makes it easier to define the presentation area 172 as is best suitable for its purpose, e.g adapted to the specific location 171 and/or the digital content it is associated with the presentation area.

The presentation area and how it relates to embodiments herein will be further discussed below.

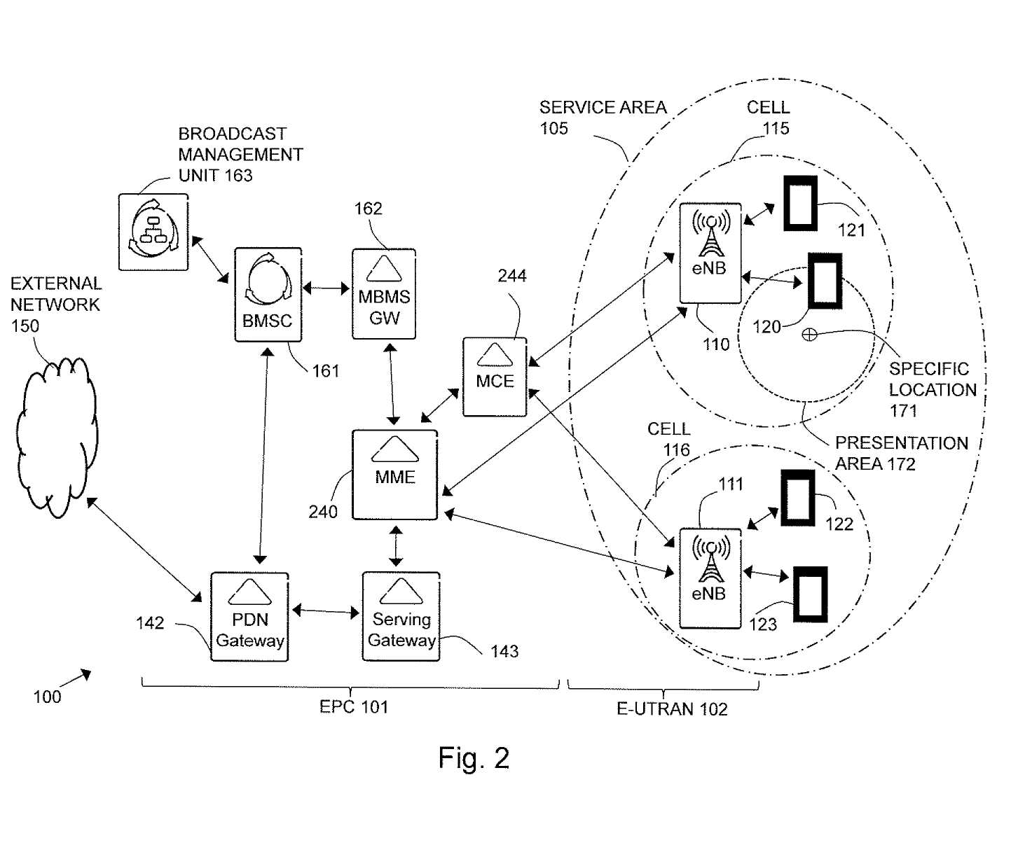

FIG. 2 is a schematic block diagram depicting another view of the example in FIG. 1, here regarding session control signalling, instead of communication of user plane data as in FIG. 1. The two different view are for reducing complexity in each view for readability reasons. The difference between session control signalling and communication of user plane data, should be well known to the person skilled in cellular communications networks, in particular LTE. For example, session control signalling typically involve setting up and configuring data bearers that are used for the communication of user plane data. Hence, the cellular communications network 100 may also comprise a Mobility Management Entity (MME) 240, known from e.g. LTE, that communicates with the eNBs, here base stations 110 and 111, and the Serving Gateway 143. The MME 240 may be regarded as main responsible for the session control signalling and setting up and configuring of data bearers for user plane traffic to and from the user equipments 120-123. This is also the case for MBMS related traffic for LTE, but where the MME 240, as shown, communicates with the MBMS GW 162 instead of the Serving Gateway 143. In case of data bearers that are MBMS related, the MME 240 may not communicate directly with the eNBs, here base stations 110, 111, but via a Multi-cell/multicast Coordination Entity (MCE) 244, as shown in FIG. 2. The MME 240 is a logical unit, which may be implemented in a corresponding physical unit, or together with other logical units or functionality in one or more shared physical units. The MME 240 is a network node in the cellular communications network 100, or more particularly, as shown, in the EPC network 101 thereof. The MCE 244 is also a logical unit, which may be implemented in a corresponding physical unit, or together with other logical units or functionality in one or more shared physical units. For example, there may be one MME 244 that corresponds to a physical unit communicatively connected to several base stations, such as with base stations 110, 111, as shown in FIG. 2, or there may be several MMEs, a respective one for and integrated with each base station.

Session control signaling for embodiments herein when implemented in an LTE and eMBMS based cellular communications network 100, as shown in FIG. 1 and FIG. 2, may follow normal procedures and will therefore not be discussed in any further detail in the following. For example, how the BMSC 161 has been configured and what digital content to broadcast or multicast, does not affect the procedures for the session control signaling as such. The skilled person with knowledge of LTE and eMBMS will realize what session control signaling will be involved and may be needed for implementation of embodiments herein,

When the digital content is provided by broadcast or multicast instead of unicast, the result is that one and the same copy of the digital content may be received by multiple user equipments at the same time, instead of sending and addressing a separate copy of the digital content to each one of multiple user equipments, e.g. each one of the user equipments 120-123, as in the case of unicast. Hence multiple unicast downlink transmissions, e.g. one for each one of individual user equipments, where each unicast transmission would require a certain bandwidth, are possible to replace by broadcast or multicast with a bandwidth that is independent on the number of receiving user equipments. This may be used to reduce the risk of capacity overload in the cell or cells subject to the broadcast or multicast. However, this does not happen automatically just because e.g an LTE based cellular communications network is supporting eMBMS. There should e.g. be services available to users and that should be attractive enough to be used. Moreover, there is a freedom of choice in what digital content that is to be subject for broadcast or multicast and where to provide the broadcast or multicast. Another issue is how to get a user equipment to receive and utilize the digital content. This will be dealt with in the following, in context of embodiments herein.

However, first it is again reminded that FIG. 1 and FIG. 2 are only schematic and for exemplifying purpose. The cellular communications network 100 may in reality comprise several further cells, base stations, user equipments, and other network nodes, including management entities, which are not shown herein. Hence, the situation shown in FIG. 1 and FIG. 2 and discussed above, is not in every detail a prerequisite for embodiments herein, as should be understood by the skilled person, and in particular when considering the present application as a whole. For example, FIG. 1 only shows one service area, while embodiments herein are relevant also when the cellular communications network 100 comprises several service areas, for example a respective service area for each population dense area, such as city area, with an expected or known high utilization degree of the capacity provided by the cells of the cellular communications network 100 in that area. Also, in FIG. 1 and FIG. 2 it is only shown two cells 115, 116 in the shown service area 105, however, in some embodiments there may be one or more service areas comprising only a single cell, i.e. the service area 105 may correspond to a single cell, although a more typical situation is that the service area 105 comprises say at least ten, hundreds or even thousand cells, for example every cell in a large city. Moreover, there is only shown one presentation area 172, however, typically there are many different presentation areas comprised in the service area 105, each associated with one or more different digital contents. One or many of the presentation areas may correspond to a respective sub-area of the service area 105 and one or more presentation areas may each comprise one or more sub-areas of one or more cells of the cellular communications network 100. For example, in some embodiments there may be a presentation area that is comprised in both the cells 115 and 116 and that may comprise a sub-area of each cell 115, 116. In some embodiments the cellular communications network 100 is a cellular communications network.

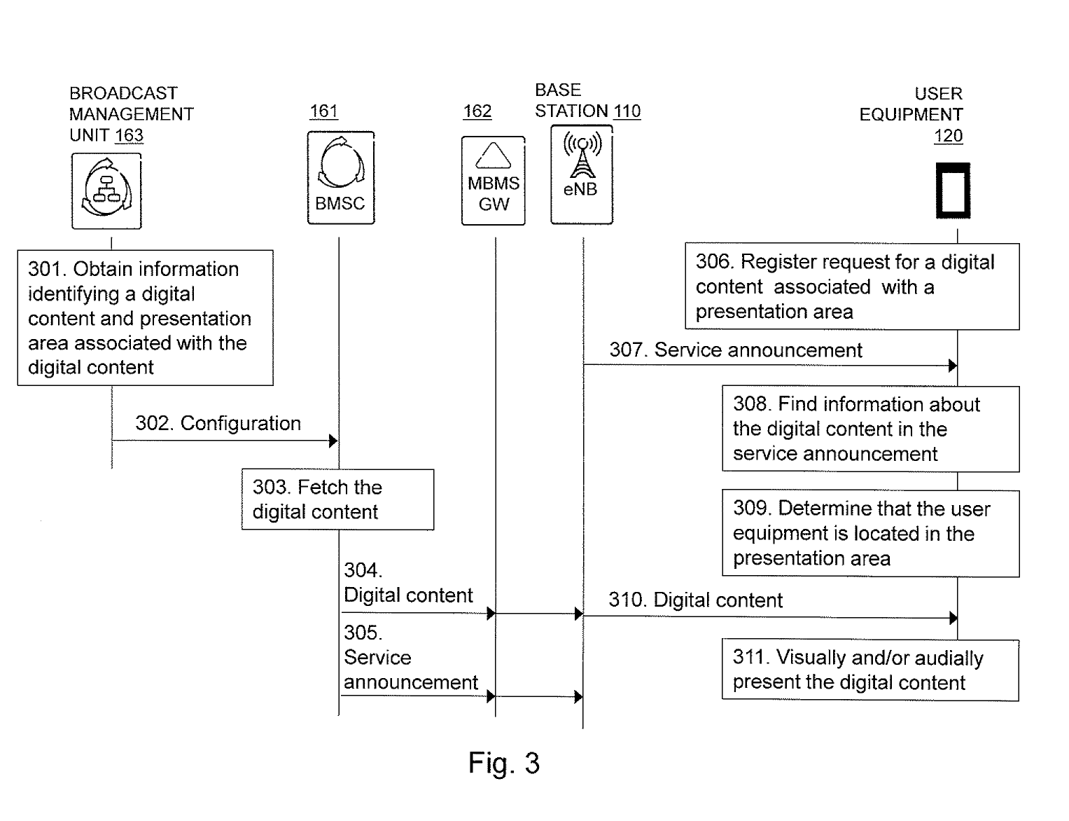

Examples of embodiments herein relating to a method in the broadcast management unit 163 for providing digital content to the first user equipment 120, will now be described with reference to the combined signaling diagram and flowchart depicted in FIG. 3. The actions may be taken in any suitable order.

Action 301

The broadcast management unit 163 obtains information identifying a digital content and the presentation area 172 associated with the digital content.

The obtained information may e.g. comprise a copy of the digital content as such or a link or network path to where it is available.

The presentation area 172 may be identified explicitly or implicitly. When the area is explicitly identified it may e.g. be identified based on one or more geographical positions comprised in the presentation area 172. When the presentation area 172 is identified based on one or more geographical positions, this may e.g. involve an inner position combined with a distance associated therewith, such that the presentation area is defined by all geographical positions within the distance from the inner position. The inner position may e.g. correspond to coordinates of the specific location 171 and the distance to a radius value. Implicit identification of the presentation area 172 may e.g. involve identifying the specific location 171 and that the presentation area 172 corresponds to a geographical area within a predetermined distance from the specific location 171, or that the presentation area 172 corresponds to a cell, e.g. cell 115, of the cellular communications network 100 that has best radio coverage at the specific location 171. In some embodiments there may be a presentation area identified based on one or more identities of cells of the cellular communications network 100. In a special case the service area 105, a cell, e.g. cell 115, comprised therein and the presentation area 172, may corresponds to one and the same area, and by obtaining information identifying the digital content, the presentation area 172 may thus implicitly be identified as the service area 105.

Action 302

The broadcast management unit 163 sends, in response to the decision in Action 301, a configuration for configuring the BMSC 161 to accomplish the broadcast or multicast according to the decision.

The configuration may e.g. comprise one or more of the following: an identifier of the digital content so that the BMSC 161 is able to fetch and use the digital content for the broadcast or multicast, an identifier of the cell or cells, e.g. the cell 115, where the broadcast or multicast is to be provided, an identifier identifying the presentation area 172, a bandwidth and/or bandwidth limits to be used for the broadcast or multicast, information about when to start and/or when to stop the broadcast or multicast of the digital content, information to be comprised in the Service Announcement (see e.g. Action 305 below), information to be used for tagging the digital content (see e.g. Action 304 below). The information to be used for tagging may fully or partly be comprised in the obtained information for identifying the digital content.

The identifier of the digital content may refer to digital content provided from the one or more support units 164 discussed above, e.g. the content providing unit or the data carousel providing unit, or may be an identifier referring to content available elsewhere, e.g. in the external network 150, such as the Internet. An identifier of the service area 105 may be regarded an identifier of the cell 115 when it is known that the cell 115 is comprised in the service area 105. In some embodiments the cell 115 may be predetermined for the broadcast or multicast and thereby may be already known to the BMSC 161 and thus no identifier of the cell 115 need to be comprised in the configuration. This may e.g. be the case for embodiments where the BMSC 161 is configured to serve one and the same, or even is associated with only one, service area in the cellular communications network 100.

The identifier identifying the presentation area 172 is preferably sent in the configuration in a format that that the first user equipment 120 is able to interpret as a geographical area or at least in a format that is comparable to positions of the first user equipment 120, which positions are obtainable by the first user equipment 120. Using such format in the configuration reduces the need for any further conversion, which e.g. facilitates handling in the BMSC 161 as will be realized from the next actions. The broadcast management unit 163 may itself, or by assistance from one or more of the support units 164, have produced the identifier identifying the presentation area 172 based on the obtained information in Action 301, or said identifier may simply have been be copied from the obtained information. The former case may involve that an explicit identifier is produced based on an implicitly identified presentation area. The broadcast management unit 163 may in such case e.g. identify that the digital content is from a particular provider or producer and may previously have been informed, i.e. it is predetermined, that all digital content from this producer or provider shall be associated with a particular presentation area.

In some embodiments, support for providing the broadcast or multicast is provided by the one or more support units 164, discussed above. In embodiments with one or more support units 164, the BMSC 161 may use the received configuration to configure and/or instruct one or more of the support units to provide the support. In some embodiments, the configuration may be sent by the broadcast management unit 163 to one or more of the support units 164 that may forward it to the BMSC 161 or may use it to further configure and/or instruct the BMSC and/or one or more other support units.

In some embodiments there may be several configurations and/or instructions sent by the broadcast management unit 163. One or more of said several configurations and/or instructions may be sent to respective one or more support units 164 to make the one or more support units 164 provide the support. For example, a decision to let the broadcast management unit 163 provide the digital content by broadcast or multicast in the service area 105 may in some embodiments be followed by that the broadcast management unit 163, in response thereto, sends a configuration to the scheduling unit comprised in the one or more support units 164. The scheduling unit may then, in response, schedule the broadcast or multicast and, in accordance with the schedule, initiate the broadcast or multicast directly with the BMSC 161, via the broadcast management unit 163 or via the data carousel unit also comprised in the one or more support units 164. When the data carousel unit is involved, the data carousel unit may fetch the digital content from or via the content providing unit, also comprised in the one or more support units 164, and may then provide a data carousel comprising the digital content to the BMSC 161 for accomplishing the broadcast or the multicast. The BMSC 161 may fetch the digital content for the broadcast or multicast from or via the content providing unit, e.g. such digital content that is not first to be arranged in a data carousel by the data carousel unit.

Action 303

The BMSC 161 fetches the digital content for the broadcast or multicast in response to received configuration. The BMSC 161 may fetch the digital content from the external network 150, e.g. the Internet, via the PDN Gateway 142, or the digital content may be fetched from within the cellular communications network 100. In some embodiments it is fetched from or via the content providing unit comprised in the one or more support units 164, discussed above. Note that even in a case when the BMSC 161, in response to the received configuration, fetches the digital content from the external network 150 instead from an internal storage of e.g. the content providing unit as discussed above, the fetched digital content may still be stored temporarily in an internal storage, e.g. located in the BMSC 161 or in the data carousel unit as discussed above, until it is time to use the digital content to provide the broadcast or multicast, e.g. by adding the digital content to a data carousel subject to the broadcast or multicast.

Action 304

The BMSC 161 sends the fetched digital content, via the MBMS GW 162, to the base stations 110, 111 in the service area 50. The base stations 110, 111 receive the digital content and broadcast or multicast the received digital content in respective cell 115, 116.

In some embodiments, an identifier for identifying the digital content, among other digital content that is provided by broadcast or multicast, as such digital content that is associated with a presentation area, and/or the above mentioned identifier identifying the presentation area 172 may be added to and/or associated with the digital content, e.g. the above-mentioned MBMS packets comprising the digital content, which packages are sent by the BMSC 161. In some embodiments one or more of the identifiers may be comprised in the Service Announcement, see Action 305 below. The identifier for identifying the digital content among other digital content may be unnecessary and may be excluded, e.g. in embodiments where all digital content in the provided broadcast or multicast is digital content associated with a respective presentation area. For embodiments where the presentation area is implicitly identified, as discussed above, and where it is also other digital content in the provided broadcast or multicast than such associated with a presentation area, the identifier for identifying the digital content among other digital content may be one and the same identifier, e.g. a flag set to one and the same predetermined value, for each digital content that is associated with a respective presentation area. In some embodiments, the identifier identifying the presentation area may be the same as the identifier for identifying the digital content among other digital content.

In some embodiments the digital content in the provided broadcast or multicast may be tagged, such that the first user equipment 120, based on the tagged digital content and a user profile of, or setting in, the first user equipment 120, is able to determine that the digital content is relevant to be visually and/or audially presented by the first user equipment 120 and thereby that the digital content is relevant for receiving and/or storing. What is meant by visually and/or audially presenting the digital content will be explained in some further detail below. The tagging may be made for one or more profile groups of user equipments for which profile groups the digital content is relevant to be recommended, wherein each profile group comprises user equipments that are associated with similar user profiles and/or settings. Each such profile group may e.g. comprise one or more of the user equipments 120-123. The tagging may be added in the BMSC 161 based on the type of digital content and/or according to information provided in the configuration. In some embodiments, the tagging may be accomplished by one or more tags that may be added to and/or associated with the MBMS packages comprising the digital content, which packages are sent by the BMSC 161. The one or more tags may e.g. correspond to a value or text with a predetermined meaning. In some embodiments the one or more tags may be comprised in the Service Announcement, see Action 305 below. The tagging and the one or more tags may be unnecessary and may be excluded, e.g. in embodiments where all digital content to be visually and/or audially presented is desirable to be presented by all user equipments, e.g. all user equipments 120-123, when located in the presentation area 172.

Execution of the present action thus makes the digital content available to all user equipments being served in the cells 115, 116, including user equipments 120-123 (if broadcast) or available to multiple, but not necessarily all user equipments 120-123 (if multicast). In the latter case, the multicast may e.g. include the first user equipment 120 and exclude the second user equipment 121. However, note that availability of digital content to a user equipment does not necessarily mean that that the digital content is relevant to be visually and/or audially presented by that user equipment or even when it is relevant to be visually and/or audially presented, that it necessary will be visually and/or audially presented. This will be better understood from the actions below relating to the first user equipment 120.

Action 305

The BMSC 161 sends a Service Announcement, via the MBMS GW 162, to the base stations 110, 111 that receive the Service Announcement and broadcast or multicast the received Service Announcement in the respective cell 115, 116.

The Service Announcement identifies the digital content and the availability of the digital content in the provided broadcast or multicast. The Service Announcement comprises information to user equipments, such as the first user equipment 120, about what digital content is available by the broadcast or multicast.

In some embodiments, as mentioned above for Action 304, the identifier identifying the presentation area 172 and/or the identifier of recommended content may be comprised in the Service Announcement. The respective identifier may be added in association with a description of the digital content in the Service Announcement.

In some embodiments, as mentioned above for Action 304, the one or more tags may be comprised in the Service Announcement. The one or more tags may be added in association with a description of the digital content in the Service Announcement.

The Service Announcement may be provided as a service layer function by the BMSC 161. One purpose of the Service Announcement is to enable overview of the digital content being provided by the broadcast or multicast without having to first receive the actual digital content. The Service Announcement may thus e.g. enable faster knowledge and evaluation of the available digital content by the user equipments, e.g. the first user equipment 120.

The Service Announcement is typically, but not necessarily, comprised in a data carousel, which may be referred to as a Service Announcement carousel. In some embodiments with a Service Announcement it may e.g. be received via unicast. In e.g. eMBMS, discussed in the foregoing, the Service Announcement carousel may repeat sending Metadata Fragments at predetermined intervals, see e.g. ETSI TS 126 346 35 V9.7.0 (2012 July): Universal Mobile Telecommunications System (UMTS); LTE; Multimedia Broadcast/Multicast Service (MBMS); Protocols and codecs (3GPP TS 26.346 version 9.7.0 Release 9), Section 5.2 User Service Discovery/Announcement.

The Service Announcement carousel may be provided to the BMSC 161 by the one or more support units 164. The creation and insertion of Service Announcements in the broadcast or multicast may be arranged to follow automatically based on the digital content that is actually being provided by the broadcast or multicast, which is information that may be present in and taken from e.g. the BMSC 161, the broadcast management unit 163 and/or the one or more support units 164.

Hence, when a Service Announcement is present, it may suffice that the first user equipment 120 is able to receive and read the Service Announcement to be able to find and download the digital content that is provided by the broadcast or multicast in the cell 115 and may thereby receive information for finding and identifying the digital content.

The Service Announcement may be transmitted using an MBMS bearer that is default available to user equipments in the service area 105 where the broadcast or multicast is provided, e.g. to the first user equipment 120. For example, in LTE and eMBMS, information where to find the Service Announcement may be transmitted in a Multicast Control Channel (MCCH) that is listened to by every user equipment entering a service area where broadcast or multicast is provided.

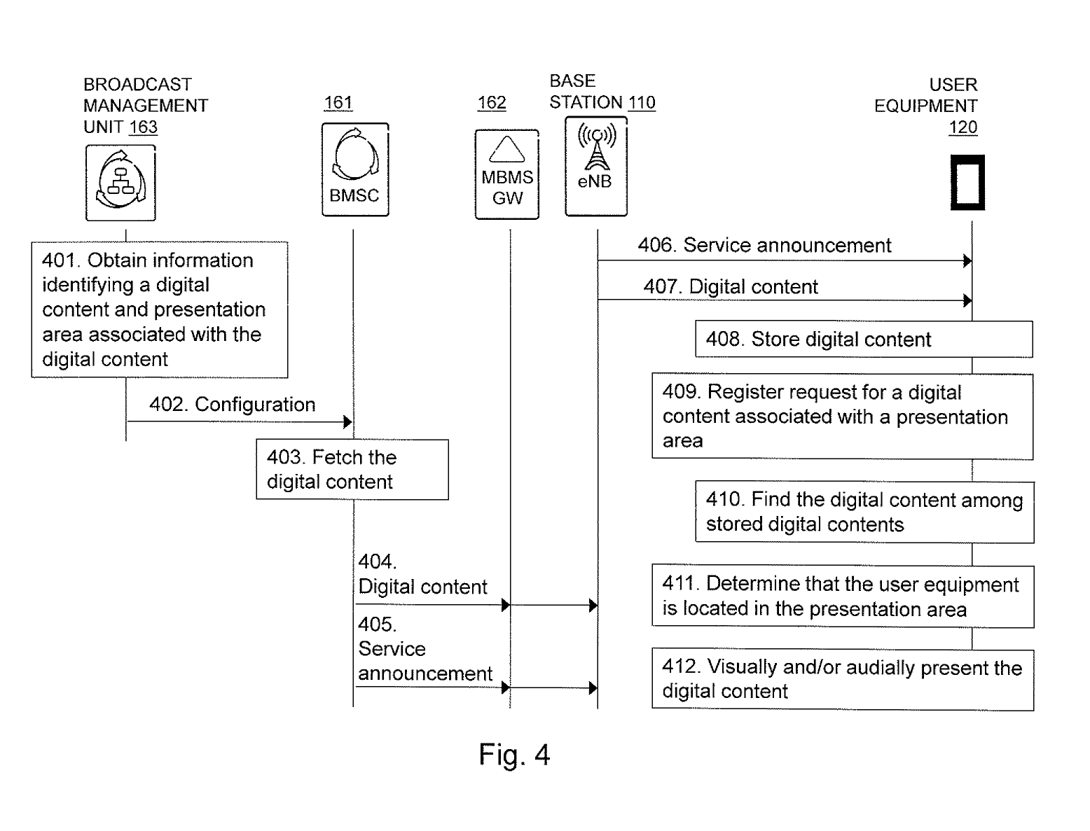

However, note that in some embodiments there may be no Service Announcement. An example of this will be given below in connection with FIG. 4.

Action 306

The first user equipment 120 registers, within the first user equipment 120, a request for such digital content that is associated with a presentation area. The request may be result from a user generated action, e.g. by selection in or start of an application for receiving and visually and/or audially presenting such digital content. The request being registered may also follow from an automatically triggered event on the user equipment, e.g. following release of some trigger that a digital content that is associated with a presentation area is available from broadcast or multicast. An application, e.g part of the operating system, may be executing on the first user equipment 120 and monitoring for broadcast or multicast of digital content associated with a presentation area and the trigger may be generated when the first user equipment 120 enters the service area 105 where such digital content is available and identifiable by the application. This may automatically, or following some user interaction, result in that the same or another application becomes active for receiving and visually and/or audially presenting such digital content. For example may there be a user setting in the first user equipment 120, which setting may have been set to that it is desirable to receive and have such digital content be automatically visually and/or audially presented when available. In some embodiments, the generated trigger may instead involve to present information on the first user equipment 120 informing about availability of such digital content and asking a question if it is desired to receive and have such digital content be visually and/or audially presented by the first user equipment 120, wherein said same or another application become active only when said question has been answered confirmative.

Note that in some embodiments there may be no request that is registered, for example in embodiments where the user equipment 120 is configured to by default proceed according to the next action.

Action 307

The first user equipment 120 receives the Service Announcement from the base station 110, which may be in response to the registered request. Purpose, how and where the first user equipment 120 may find the Service Announcement and information that may be comprised in the Service Announcement, was discussed also above, see e.g. Action 304 and Action 305.

Action 308

The first user equipment 120 finds, in the received Service Announcement, information about the digital content. The information identifies the digital content and the availability of the digital content in the provided broadcast or multicast, i.e. the information relates to how to find and receive the digital content from the provided broadcast or multicast.

The finding of the information about the digital content is typically in response to that the first user equipment 120 has checked the received Service Announcement for a digital content that is associated with a presentation area, i.e. without specific prior knowledge of what digital content may be found by the check. The check may comprise checking the Service Announcement for one or more of said identifiers identifying the respective presentation area and/or for identifying the digital content, among other digital content that is provided by broadcast or multicast, as such digital content that is associated with a presentation area.

In some emboiments the finding of the information about the digital content is in response to that the first user equipment 120 has checked the received Service Announcement for said one or more tags as discussed above for Action 304 and Action 305. The first user equipment 120 may thereby be able to identify the digital content as relevant for visual and/or audial presentation by the first user equipment 120. It is here and below assumed that the digital content is relevant to be visually and/or audially presented by the first user equipment 120.

In some embodiments the information found in the present action comprises the identifier identifying the presentation area 172. In some embodiments, the identifier identifying the presentation area 172 have been added to and is available from the digital content and hence, by being enabled to find the digital content in the provided broadcast or multicast, the user equipment 120 is also enabled to find the identifier identifying the presentation area 172.

Action 309

The first user equipment 120 determines that the user equipment 120 is located in the presentation area 172. The user equipment may have been informed about the presentation area 172 through the identifier identifying the presentation area, which identifier may have been received as described above for action 308.

The present action may follow from that the first user equipment 120, in response to that it found the information about the digital content in the Service Announcement, has started to monitor its own position and compare its own position with the presentation area 172. The first user equipment 120 monitoring its position may comprise that the user equipment 120 receives position data from or via some positioning service available to the first user equipment, which e.g. may comprise receiving position data at least partly from an integrated GPS-receiver and/or position data from the base station 110 and/or from one or many additional, typically neighboring base stations, such as the base station 111. In some embodiments, as mentioned above, with a presentation area identified by a cell identity, e.g. a cell identity of the cell 115, the determination may comprise comparing the cell identity of such presentation area with that of the cell 115, which e.g. would match when the first user equipment 120 is being served in the cell 115.

Action 310

The first user equipment 120 receives the digital content by broadcast or multicast from the base station 110. This may be in response to that the information about the digital content was found in the Service Announcement and/or in response to that the first user equipment 120 has determined that the first user equipment 120 is located in the presentation area 172. Note that is some embodiments, as e.g. will be shown in connection with FIG. 4 below, the digital content may be received before it is determined that the first user equipment is located in the presentation area 172. The first user equipment 120 may in some embodiments receive the digital content in response to that it, based on said one or more tags, has been determined that the digital content is relevant to be visually and/or audially presented by the first user equipment 120.

Action 311

The first user equipment 120 visually and/or audially presents the received digital content, typically automatically, in response to the the first user equipment 120 has determined that the the first user equipment 120 is located in the presentation area 172.

By the first user equipment 120, or a user equipment in general, visually and/or audially presenting the digital content is herein meant that information comprised the digital content is visually and/or audially presented in a way suitable for informing a user of the first user equipment 120. Visual presentation is typically accomplished by displaying the information, e.g. text, graphics, video, on a display of the first user equipment 120, and audial presentation is typically accomplished by playing the information, e.g. audio, through a loudspeaker of or headset connected to the first user equipment 120.

The presentation may be performed directly, or as soon as possible, after receipt or even during receipt, for example in case of streamed digital content, such as streamed, e.g, live, video or audio. The presentation may in some embodiments be performed with some delay after receipt, e.g. in embodiments where the digital content is received prior to that it is determined that the first user equipment 120 is located in the presentation area 172.

Typically the presentation is performed through an application executing on the first user equipment 120 and that is dedicated for accessing the digital content. For example, a web browser application may be used for accessing to digital content that corresponds to a web page, a video viewing application for accessing a video clip, just to mention some few examples.

When the digital content is fully or partly application specific, as mentioned above, the digital content, and one or more other digital contents that are associated with a respective presentation area, but that are of different types, e.g. text and video content, are typically presented through one and the same application. In embodiments starting with an action as described above for Action 306, e.g. with the request being registered within the first user equipment 120 in response to selection in, or start of an application, for receiving and presenting such digital content that is associated with a presentation area, the visual and/or audial presentation in this action is typically performed through the same application.

Some more practical and use case related examples enabled by embodiments herein and a discussion regarding advantages will follow below after the examples of embodiments described with reference to FIG. 4.

Examples of embodiments herein relating to a method in the Broadcast management unit 163 for recommending and providing digital content to the first user equipment 120, will now be further described with reference to the combined signaling diagram and flowchart depicted in FIG. 4.

As may be noted, the difference compared to the combined signaling diagram and flowchart depicted in FIG. 3 and discussed above, is relating to the first user equipment 120. Actions 401-405 may correspond to Action 301-305 described above and will therefore not be further described here. The actions may be taken in any suitable order.

Action 406

The first user equipment 120 receives the Service Announcement from the base station 110. The user equipment may be configured to receive the Service Announcement automatically, e.g. repeatedly or when in an idle state or in a situation when the first user equipment 120 has spare capacity for doing so. This enables the first user equipment 120 to identify changes in digital content available from broadcast or multicast. How and where the first user equipment 120 may find the Service Announcement was discussed above under Action 305.

Action 407

The first user equipment 120 receives the digital content from the provided broadcast or multicast, e.g. in response to that the first user equipment 120 has found where to find the digital content based on the received Service Announcement. The first user equipment 120 may start to receive the digital content as soon as possible after the first user equipment 120 has entered the service area 105 if the same digital content is provided by broadcast and multicast in all cells, e.g. cells 115, 116, in the service area 105, or may start to receive the digital content as soon as possible after the first user equipment 120 has entered the cell 115. In some embodiments the first user equipment receives the digital content as a result from that the first user equipment 120 receives all digital contents that is available according to the Service Announcement. In general, the first user equipment 120 may only receive digital content that not previously has been received and/or stored, e.g. receive digital content when a change in the provided digital content has been identified in the Service Announcement and which change indicate new digital content that may be relevant for the first user equipment 120. For further comments in this regard, see Action 408.

Action 408

The first user equipment 120 stores the received digital content, typically in an internal storage on the first user equipment 120. In some embodiments the first user equipment 120 stores the digital content as a result from that all digital content that was received are stored.

In some embodiments, information from the Service Announcement may be stored with the digital content, e.g. if corresponding information has not previously been added to and is available from the received digital content. Such information may comprise the identifier identifying the presentation area and/or the identifier for identifying the digital content, among other digital content that is provided by broadcast or multicast, as such digital content that is associated with a presentation area, and/or may comprise said one or more tags as discussed above for Action 304 and Action 305.

In some embodiments the first user equipment 120 stores the digital content only if it fulfills certain criteria and e.g. not previously has been stored, i.e. a subset of received digital content in the provided broadcast or multicast may be stored. In some embodiments the criteria may comprise that the digital content is a type of digital content that is associated with a presentation area, which may be determined based on the identifier identifying the presentation area and/or the identifier for identifying the digital content, among other digital contents, as a digital content that is associated with a presentation area. These identifiers may be available from the Service Announcement and/or may have been added to and be available from the received digital content. In some embodiments the criteria may comprise that the digital content is relevant to be visually and/or audially presented by the user equipment, which may be determined based on the one or more tags as discussed above for Action 304 and Action 305 and a user profile of, and/or setting in, the first user equipment 120. Said one or more tags may be available from the Service Announcement and/or may have been added to the digital content and is thus available from the received digital content. For example, as mentioned above, the digital content may be tagged for one or more profile groups of user equipments for which the digital content is relevant, wherein each profile group comprises user equipments that are associated with similar user profiles and/or settings, e.g. one or more or user equipments 120-123. The first user equipment 120 may thus, based on a user profile or setting of its own that is available on the first user equipment 120, determine that the digital content is relevant to be visually and/or audially presented by the first user equipment 120 and based on this store the digital content.

Action 409

The first user equipment 120 registers, within the first user equipment 120, a request for such digital content that is associated with a presentation area. This action may correspond to Action 306 above and is therefore not further discussed here.

Action 410

The first user equipment 120 finds the digital content among digital contents that have been stored. This may be in response to the registered request in the previous action.

In embodiments where all digital contents that have been stored are such associated with a respective presentation area and are relevant to be visually and/or audially presented by the first user equipment 120, the present action may comprise to select one of the stored digital contents.

In embodiments where e.g. not only digital contents associated with a respective presentation area, and/or not only digital contents relevant to be presented on the first user equipment 120 have been stored, the present action may involve to first check the digital contents that have been stored specifically for a digital content that is associated with a presentation area, without specific prior knowledge of any digital content that is found by the check. The check may comprise checking the digital content for one or more of said identifiers identifying the respective presentation area and/or for identifying the digital content, among other digital contents that are provided by broadcast or multicast, as a digital content that is associated with a presentation area. The check may also comprise checking the digital content for said one or more tags as discussed above for Action 304 and Action 305.

When the digital content has been found typically also the identifier identifying the presentation area 172 is found. For example, as described above, the identifier of the presentation area may have been added to the digital content and thus been received and stored with the digital content, or it the identifier may have been copied from the Service Announcement and stored with the digital content.

Action 411

The first user equipment 120 determines that the user equipment 120 is located in the presentation area 172. The user equipment may have been informed about the presentation area 172 as described above for Action 410.

The present action may follow from that the first user equipment 120 started to monitor its own position and compare its own position with the presentation area 172 in response to that the first user equipment 120 found the digital content in the previous action, and thereby was informed about the associated presentation area 172. The monitoring of the position may correspond to the monitoring of position as described for Action 309.

Action 412

The first user equipment 120 visually and/or audially presents the found digital content in response to that the first user equipment 120 has determined that the first user equipment 120 is located in the presentation area 172. This action may correspond to Action 311 described above.

Hence, by providing digital content by broadcast or multicast in the service area 105 comprising the presentation area 172 and for visual and/or audial presentation by the user equipment 120 when the user equipment 120 is located in the service area, as described above in connection with FIG. 3 and FIG. 4, digital content for informing about e.g. the specific location 171 comprised in the presentation area 172 may be provided to and be visually and/or audially presented by the user equipment 120 and multiple other user equipments, e.g. the user equipments 121-123, when they are located in the presentation area 172. This can be accomplished cost efficiently and with very efficient utilization of cell capacity per user equipment. To the cost of cell capacity corresponding to what a single user equipment would require if the digital content would be provided by unicast, the embodiments herein enable all user equipments being served in the service area 105 to receive the digital content and to present it when the respective user equipment is located in the presentation area 172. This also enables a new type of location specific services that may be provided in the cellular communications network 100 and that involves digital content that is location specific for visual and/or audial presentation by user equipments, such as the user equipment 120, in the presentation area 172. See some more specific examples below. Such services may, owing to the efficient use of cell capacity per user, be provided with very low or no charging at all for the services at the user equipment end. However, revenues may instead be enabled from e.g. the providers and/or producers of the digital content, e.g. store keepers or companies behind stores, or any one that may be interested in to be able to locally deliver and present local specific digital content to a large number of users via their respective user equipment. At the same time, if the result is that user equipments focus on services based on digital content available from broadcast or multicast, this reduce the unicast load on cells in the cellular communications network 100 and thereby reduce the risk of cell capacity overload.

An example of a further advantage is that user equipments, e.g. the user equipments 120-123, receiving digital content by broadcast or multicast in the service area 105, or in respective cell therein, such as cells 115, 116, instead of by unicast, enable reduced signaling in the respective cell 115, 116 and thereby less resources may need to be allocated. For example, in LTE, less resource blocks, which may be a limited resource, may need to be allocated.

Non-limited examples relating to embodimens herein include:
The specific location 171 is a store. The presentation area 172 is a neighborhood area comprising the store, e.g. covering a shopping center where the store is located or a cell of the cellular communications network, which cell covers the store. The digital content may comprise information informing about the existence and directions to the store, offers etc.
The specific location 171 is a location worth seeing, e.g. a historical location, such as a building. The presentation area 172 is an area covering the location worth seeing, e.g. such that every location in a vicinity where the location is viewable is covered. The digital content may be an audio clip or text that describes the specific location.
The specific location 171 is a shopping area, e.g. a mall. The presentation area 172 is corresponding to shopping area or to somewhat larger area. The digital content may be a map or navigation application regarding the shopping area, indicating parking areas, shops etc, and may also include or link to offers or further information in general.
The specific location 171 is a location of a sport event, e.g. an arena. The presentation area 172 corresponds to or at least covers the location. The digital content may be an application providing results, statistics and/or other information regarding the sports event, or the digital content may be application specific digital content comprising results, statistics and/or other information regarding the sports event. In the latter case the application may be pre-installed on the user equipment and need not be location specific as such.

Another example of what is enabled by embodiments herein is the following use case, where the digital content is application specific and an application for receiving and handling the digital content is installed and executing on the first user equipment 120: The first user equipment 120 is brought by a consumer approaching a shopping area by car. Digital content is downloaded and visually and/or audially presented automatically based on the location of the first user equipment 120, e.g. when the first user equipment enters the presentation area 172 that may correspond to the shopping area. Through the application it is presented information about car parks and a recommend place to park in the shopping area. Once parked the user may select in the application that parking is completed, and further digital content that has been downloaded is presented regarding information on and location of stores that match a user profile and/or setting in the first user equipment 120. For each store there may be a link to further digital content that, if followed, results in presentation of further downloaded digital content that is presented and informs e.g. about new arrivals, offers etc, and there may be a link for being guided to the store in question.

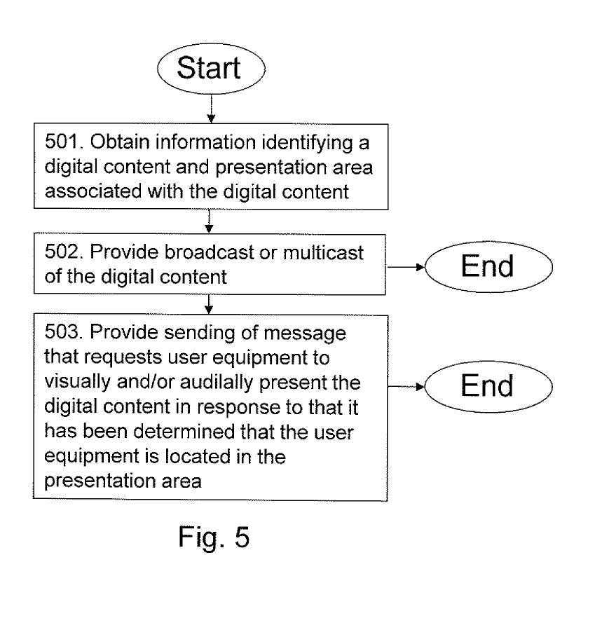

Embodiments herein relating to a method in the broadcast management unit 163 for providing a digital content to at least one user equipment will now be further elaborated and described with reference to the flowchart depicted in FIG. 5. The at least one user equipment is served by the base station 110 in the cellular communications network 100. The at least one user equipment may e.g. be one or more of the user equipments 120, 121, but will in the following, mainly for readability reasons, be represented by the first user equipment 120. The method comprises the following actions, which actions may be taken in any suitable order. Further, actions may be combined.

Action 501

The broadcast management unit 163 obtains information identifying the digital content and the presentation area 172 associated with the digital content.

In some embodiments the presentation area 172 is a sub-area of the service area 105.

In some embodiments the presentation area 172 is defined independent of one or more cells, e.g. cells 115, 116, that the presentation area 172 fully and/or partly covers in the service area 105.

This action may correspond fully or partially to the previously described Action 301 and Action 401.

Action 502

The broadcast management unit 163 provides, based on the obtained information, a broadcast or multicast of the digital content in the service area 105. The service area 105 comprises the presentation area 172 and the first user equipment 120. Thereby first user equipment 120 is enabled to, via the base station 110, receive the digital content in the service area 105 and to visually and/or audially present the digital content in response to that the first user equipment 120 has determined that the first user equipment 120 is located in the presentation area 172.

This action may correspond fully or partially to the previously described Actions 302-304 and Actions 402-404,

Action 503

This is an optional action for embodiments herein. The broadcast management unit 163 provides a sending of a message from the base station 110 to the first user equipment 120. The message requests the first user equipment 120 to visually and/or audially present the digital content in response to that the first user equipment 120 has determined that the first user equipment 120 is located in the presentation area 172. The request may be explicit but is typically implicit.

In some embodiments the message comprises an identifier for identifying the digital content, among other digital contents that are provided by broadcast or multicast, as a digital content that is associated with a presentation area.

In some embodiments the message comprises an identifier identifying the presentation area 172.

Further, in some embodiments, the message comprises one or more tags that are unique for one or more profile groups of user equipments, for which profile groups the digital content is relevant to visually and/or audially presented, wherein each profile group comprises user equipments that are associated with similar user profiles and/or settings.

Moreover, in some embodiments, the message comprises a service announcement that identifies the digital content and the availability of the digital content in the provided broadcast or multicast.

In some embodiments the message may be comprised in a data carousel that is provided by broadcast or multicast in the service area 105.

This action may correspond fully or partially to the previously described Actions 302-305 and Actions 402-405.

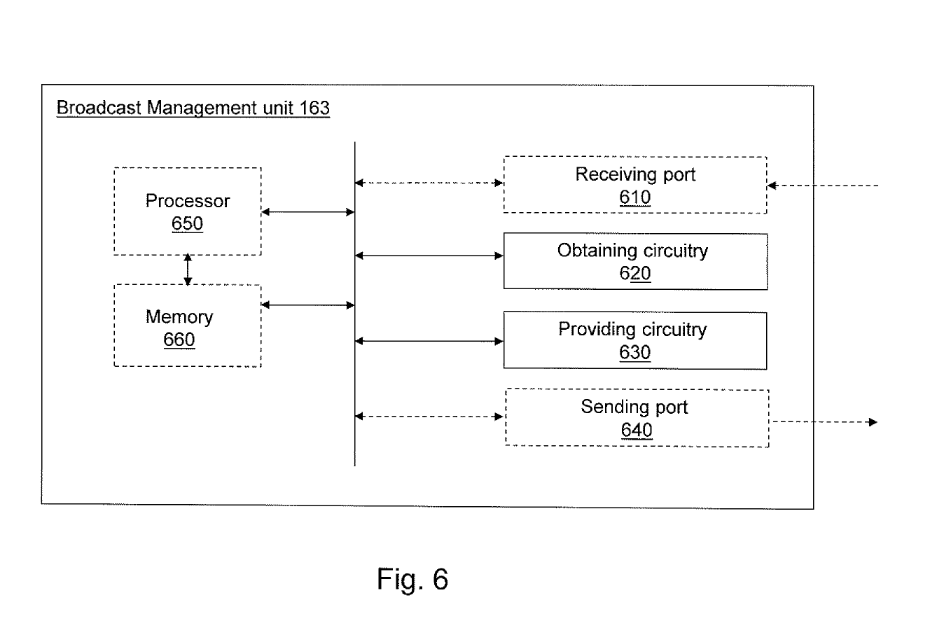

To perform the actions above for recommending and providing the digital content to the first user equipment 120, the broadcast management unit 163 may comprise an arrangement schematically depicted in FIG. 6. As mentioned above, the first user equipment 120 is served by the base station 110 in the cellular communications network 100.

The broadcast management unit 163 comprises an obtaining circuitry 620, configured to obtain the information identifying the digital content and the presentation area 172 associated with the digital content.

The broadcast management unit 163 further comprises a providing circuitry 630, configured to based on the obtained information, provide said broadcast or multicast of the digital content in the service area 105 comprising the presentation area 172.

In some embodiments, the providing circuitry 630 is further configured to provide the sending of the message from the base station 110 to the first user equipment 120, which message requests the first user equipment 120 to visually and/or audially present the digital content in response to that the first user equipment 120 has determined that the first user equipment 120 is located in the presentation area 172.

The broadcast management unit 163 may further comprise a receiving port 610 that may be configured to receive information from and be involved in communication with other units, e.g. the BMSC 161 and the one or more support units 164.

The broadcast management unit 163 may further comprise a sending port 640 that may be configured to send information to and be involved in communication with other units, e.g. the BMSC 161 and the one or more support units 164.

The embodiments of the broadcast management unit 163 may be implemented through one or more processors, such as a processor 650 in the broadcast management unit 163 depicted in FIG. 6, together with computer program code for performing the functions and actions of embodiments herein. In some embodiments the circuitry discussed above may be fully or partially implemented by the processor 650.

The computer program code mentioned above may also be provided as a computer program product, for instance in the form of a data carrier carrying computer program code for performing the embodiments herein when being loaded into the in the broadcast management unit 163. One such carrier may be in the form of a CD or DVD. It is however feasible with other data carriers such as a memory stick, memory card or hard drive. The computer program code may furthermore be provided as pure program code on a server for download to the broadcast management unit 163. The computer program code may furthermore be provided in the form of a data file or files on, or available through, a server for download. The file or files may be executable files for direct or indirect download to and execution on the broadcast management unit 163, or may be for intermediate download and compilation to make them executable before download to and for execution in the broadcast management unit 163. The server may be accessible over a computer network, such as the Internet, and may e.g. be a web or ftp server.

The broadcast management unit 163 may further comprise a memory 660 comprising one or more memory units. The memory 660 is arranged to store data, such as values mentioned above relating to configuration/s and/or the instructions/s that may be sent to the BMSC 161 and/or the one or more support units 164, and/or to the measures and parameters for the decision, etc., and configurations and/or applications to perform the method when being executed in the broadcast management unit 163.

Those skilled in the art will also appreciate that the circuitry and ports 610-640 may refer to a combination of analog and digital circuits, and/or one or more processors configured with software and/or firmware (e.g., stored in memory) that, when executed by the one or more processors such as the processor 650, perform as described above. One or more of these processors, as well as the other digital hardware, may be included in a single application-specific integrated circuit (ASIC), or several processors and various digital hardware may be distributed among several separate components, whether individually packaged or assembled into a system-on-a-chip (SoC).

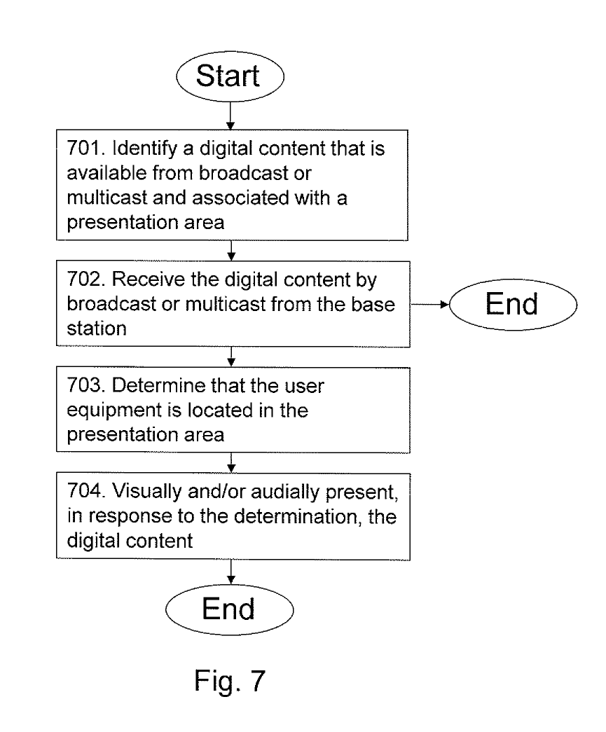

Embodiments herein relating to a method in the first user equipment 120 for receiving a digital content, will now be further elaborated and described with reference to the flowchart depicted in FIG. 7. The first user equipment 120 is served by the base station 110 in the cellular communications network 100.

The method comprises the following actions, which actions may be taken in any suitable order. Further, actions may be combined.

Action 701

The first user equipment 120 identifies that the digital content is available from a broadcast or multicast in the service area 105 and is associated with the presentation area 172. The service area 105 comprises the presentation area 172 and the first user equipment 120.

In some embodiments the presentation area 172 is a sub-area of the service area 105. Further, in some embodiments, the presentation area 172 is defined independent of one or more cells, e.g. cells 115, 116, that the presentation area 172 fully and/or partly covers in the service area 105.

That the first user equipment 120 identifies the digital content, as described above, may in some embodiments comprise that the first user equipment 120 receives, from the base station 110, a message that requests the first user equipment 120 to visually and/or audially present in response to that the first user equipment 120 has determined that the first user equipment 120 is located in the presentation area 172.

In some embodiments the message comprises an identifier for identifying the digital content, among other digital contents that are provided by broadcast or multicast, as a digital content that is associated with a presentation area.

In some embodiments the message comprises an identifier identifying the presentation area 172.

Further, in some embodiments, the message comprises one or more tags that are unique for one or more profile groups of user equipments, for which profile groups the digital content is relevant to be visually and/or audially presented, wherein each profile group comprises user equipments that are associated with similar user profiles and/or settings.

Moreover, in some embodiments, the message comprises a service announcement that identifies the digital content and the availability of the digital content in the provided broadcast or multicast.

In some embodiments the message is comprised in a data carousel that is provided by broadcast or multicast in the service area 105.

That the first user equipment 120 identifies the digital content, as described above, may in some embodiments comprise that the first user equipment 120 stores the received digital content prior to that the first user equipment 120 has determined that the first user equipment 120 is located in the presentation area 172, and may further comprise that the first user equipment 120 finds the digital content among stored digital contents.

This action may correspond fully or partially to the previously described Actions 307-308 and Actions 407-408, 410.

Action 702

The first user equipment 120 receives the digital content by broadcast or multicast from the base station 110. Thereby the first user equipment 120 is enabled to visually and/or audially present the digital content in response to that the first user equipment 120 has determined that the first user equipment 120 is located in the presentation area 172. Note that in some embodiments the first user equipment 120 may receive the digital content prior to Action 701 and that in some embodiments the first user equipment 120 may receive the digital content after Action 703.

This action may correspond fully or partially to the previously described Action 310 and Action 407.

Action 703

This is an optional action for embodiments herein. The first user equipment 120 determines that the first user equipment 120 is located in the presentation area 172.

This action may correspond fully or partially to the previously described Action 309 and Action 411.

Action 704

This is an optional action for embodiments herein. The first user equipment 120 presents, in response to that it has been determined that the first user equipment 120 is located in the presentation area 172, the digital content visually and/or audially. In some embodiments, the first user equipment 120 presents the digital content in response to that first user equipment has determined that the digital content is relevant for the first user equipment 120 based on said one or more tags and a user profile of and/or setting in the first user equipment 120.

This action may correspond fully or partially to the previously described Action 311 and Action 411.

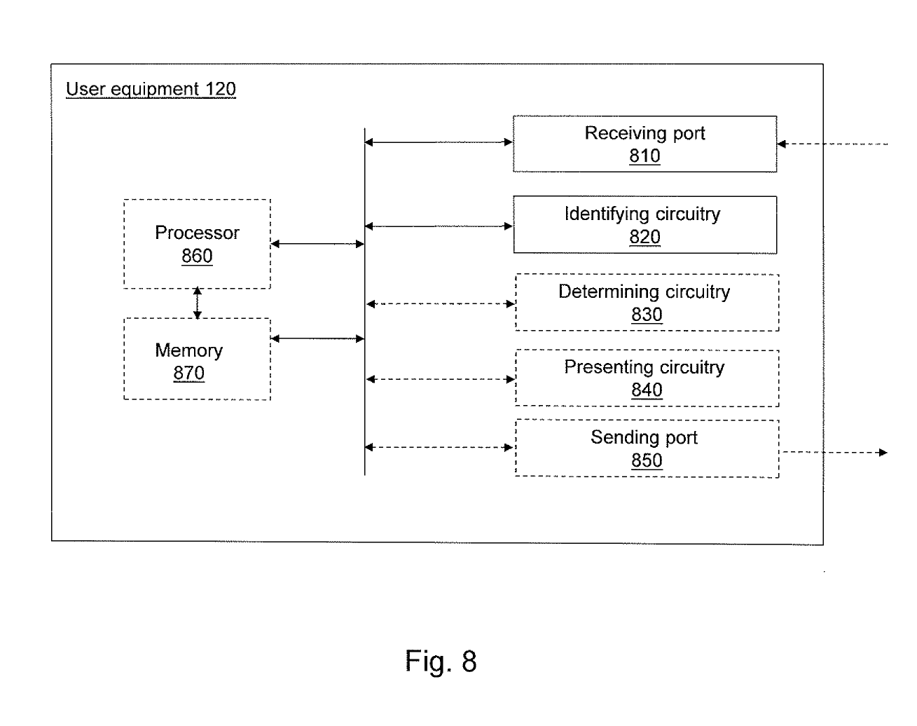

To perform the actions above for receiving the digital content, the first user equipment 120 may comprise an arrangement schematically depicted in FIG. 8. As mentioned above, the first user equipment 120 is served by the base station 110 in the cellular communications network 100.

The first user equipment 120 comprises a receiving port 810, configured to receive the digital content by said broadcast or multicast from the base station 110. Thereby the first user equipment 120 is enabled to visually and/or audially present the digital content in response to that the first user equipment 120 has determined that the first user equipment 120 is located in the presentation area 172. The receiving port 810 may further be configured to receive information in general from and be involved in communication with the base station 110. For example may the identifying circuitry 820 described below receive information from the base station 110 via the receiving port 810.

The first user equipment 120 may further comprises an identifying circuitry 820, configured to identify that the digital content is available from said broadcast or multicast in the service area 105 and is associated with the presentation area 172.

In some embodiments the identifying circuitry 820 is further configured to receive, from the base station 110, the message that requests the user equipment 120 to visually and/or audially present the digital content on the first user equipment 120 in response to that the first user equipment 120 has determined that the first user equipment 120 is located in the presentation area 172. As already mentioned above, in some embodiments, the message comprises said one or more tags that are unique for one or more profile groups of user equipments, for which profile groups the digital content is relevant to be visually and/or audially presented, wherein each profile group comprises user equipments that are associated with similar user profiles and/or settings.

In some embodiments, the identifying circuitry 820 is further configured to store the received digital content prior to that the first user equipment 120 has determined that the first user equipment 120 is located in the presentation area 172, and may be further configured to find the digital content among stored digital contents.

The first user equipment 120 may further comprises a determining circuitry 830, configured to determine that the first user equipment 120 is located in the presentation area 172.

The first user equipment 120 may further comprise a presenting circuitry 840, configured to, in response to that the determining circuitry 830 has determined that the first user equipment 120 is located in the presentation area 172, visually and/or audially present the digital content.

The presenting circuitry 840 may in some embodiments be configured to present the digital content on the first user equipment 120 in response to that the first user equipment 120 has determined that the digital content is relevant for the first user equipment 120 based on the one or more tags comprised in the message that the identifying circuitry 120 may be configured to receive as described above.

The first user equipment 120 may further comprise a sending port 850 that may be configured to send information to and be involved in communication with the base station 110.

The embodiments of the first user equipment 120 may be implemented through one or more processors, such as a processor 860 in the first user equipment 120 depicted in FIG. 8, together with computer program code for performing the functions and actions of embodiments herein. In some embodiments the circuitry discussed above may be fully or partially implemented by the processor 860.

The computer program code mentioned above may also be provided as a computer program product, for instance in the form of a data carrier carrying computer program code for performing the embodiments herein when being loaded into the in the first user equipment 120. One such carrier may be in the form of a CD or DVD. It is however feasible with other data carriers such as a memory stick, memory card or hard drive. The computer program code may furthermore be provided as pure program code on a server for download to the first user equipment 120. The computer program code may furthermore be provided in the form of a data file or files on, or available through, a server for download. The file or files may be executable files for direct or indirect download to and execution on the first user equipment 120, or may be for intermediate download and compilation to make them executable before download to and for execution in the first user equipment 120. The server may be accessible over a computer network, such as the Internet, and may e.g. be a web or ftp server.

The first user equipment 120 may further comprise a memory 870 comprising one or more memory units. The memory 870 is arranged to store data, such as the Service Announcement during and after it has been received, and configurations and/or applications to perform the method when being executed in the first user equipment 120.

Those skilled in the art will also appreciate that the circuitry and ports 810-850 may refer to a combination of analog and digital circuits, and/or one or more processors configured with software and/or firmware (e.g., stored in memory) that, when executed by the one or more processors such as the processor 860, perform as described above. One or more of these processors, as well as the other digital hardware, may be included in a single application-specific integrated circuit (ASIC), or several processors and various digital hardware may be distributed among several separate components, whether individually packaged or assembled into a system-on-a-chip (SoC).

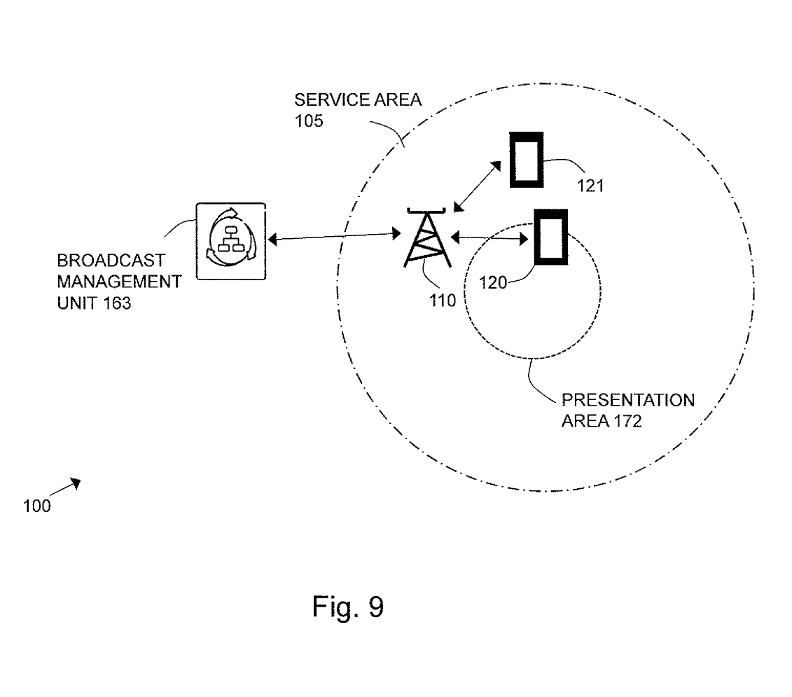

FIG. 9 is a schematic block diagram depicting a simplified view of the cellular communications network 100. Features mentioned above in connection with FIGS. 5-8 remain while other details have been left out.

Many embodiments and examples that have been described and discussed herein relate to a LTE-based cellular communications network, and in particular a cellular communications network that has been enhanced with MBMS functionality, such as eMBMS. However, although it has been shown that embodiments herein are compatible with and may advantageously be implemented in such networks, this is not to be construed as limiting embodiments herein to only such networks. Generally, embodiments herein are not limited to the above described preferred embodiments. Various alternatives, modifications and equivalents may be used. Therefore, the above embodiments should not be taken as limiting the scope of the invention, which is defined by the appending claims.

When using the word “comprise” or “comprising” it shall be interpreted as non-limiting, i.e. meaning “consist at least of”.

1. A method in a broadcast management unit for providing a digital content to at least one user equipment being served by a base station in a cellular communications network, wherein the method comprising:
obtaining information identifying the digital content and a presentation area associated with the digital content; and
providing, based on the obtained information, one of a broadcast and multicast of the digital content in a service area, which service area comprises the presentation area and the at least one user equipment, thereby enabling the at least one user equipment to, via the base station, receive the digital content in the service area and to at least one of visually and audially present the digital content in response to that the at least one user equipment has determined that the at least one user equipment is located in the presentation area.

2. The method of claim 1, wherein the method further comprises:
providing a sending of a message from the base station to the at least one user equipment, which message requests the at least one user equipment to at least one of visually and audially present the digital content in response to that the at least one user equipment has determined that the at least one user equipment is located in the presentation area.

3. The method of claim 2, wherein the message comprises an identifier for identifying the digital content, among other digital contents that are provided by broadcast or multicast, as a digital content that is associated with a presentation area.

4. The method of claim 2, wherein the message comprises an identifier identifying the presentation area.

5. The method of claim 2, wherein the message comprises at least one tag that is unique for at least one profile group of user equipments, for which profile groups the digital content is relevant to be at least one of visually and audially presented, wherein each profile group comprises user equipments that are associated with at least one of similar user profiles and settings.

6. The method of claim 2, wherein the message comprises a service announcement that identifies the digital content and the availability of the digital content in the provided broadcast or multicast.

7. The method of claim 2, wherein the message is comprised in a data carousel that is provided by broadcast or multicast in the service area.

8. The method of claim 1, wherein the presentation area is a sub-area of the service area.

9. The method of claim 1, wherein the presentation area is defined independent of at least one cell that the presentation area at least one of partly covers in the service area.

10. A method in a user equipment for receiving a digital content, the user equipment being served by a base station in a cellular communications network, the method comprising:
identifying that the digital content is available from one of a broadcast and multicast in a service area and is associated with a presentation area, which service area comprises the presentation area and the user equipment; and
receiving the digital content by one of broadcast and multicast from the base station, thereby enabling the user equipment to at least one of visually and audially present the digital content in response to that the user equipment has determined that the user equipment is located in the presentation area.

11. The method of claim 10, wherein the method further comprises:
determining that the user equipment is located in the presentation area; and
presenting, in response to the determining, the digital content at least one of visually and audially.

12. The method of claim 10, wherein the identifying comprises:
receiving, from the base station, a message that requests the user equipment to at least one of visually and audially present the digital content in response to that the user equipment has determined that the user equipment is located in the presentation area.

13. The method of claim 12, wherein the message comprises an identifier for identifying the digital content, among other digital contents in the provided broadcast or multicast, as a digital content that is associated with a presentation area.

14. The method of claim 12, wherein the message comprises an identifier identifying the presentation area.

15. The method of claim 12, wherein the message comprises at least one tag that is unique for at least one profile group of user equipments for which profile groups the digital content is relevant to be at least one of visually and audially presented, wherein each profile group comprises user equipments that are associated with at least one of similar user profiles and similar settings, and wherein any at least one of visually and audially presenting of the digital content is made in response to that the user equipment has determined that the digital content is relevant for the user equipment based on said at least one tag and at least one of a user profile of and setting in the user equipment.

16. The method of claim 12, wherein the message comprises a service announcement that identifies the digital content and the availability of the digital content in the provided one of broadcast and multicast.

17. The method of claim 12, wherein the message is comprised in a data carousel that is provided by one of broadcast and multicast in the service area.

18. The method of claim 10, wherein the identifying comprises:
storing the received digital content prior to that the user equipment has determined that the user equipment is located in the presentation area, and
finding the digital content among stored digital contents.

19. The method of claim 10, wherein the presentation area is a sub-area of the service area.

20. The method of claim 10, wherein the presentation area is defined independent of at least one cell that the presentation area fully at least partly covers in the service area.

21. A broadcast management unit for providing a digital content to at least one user equipment served by a base station in a cellular communications network, the broadcast management unit comprising:
an obtaining circuitry, configured to obtain information identifying the digital content and a presentation area associated with the digital content, and
a providing circuitry, configured to, based on the obtained information, provide one of a broadcast and multicast of the digital content in a service area, which service area comprises the presentation area and the at least one user equipment, thereby enabling the at least one user equipment to, via the base station, receive the digital content in the service area and to at least one of visually and audially present the digital content in response to that the at least one user equipment has determined that the at least one user equipment is located in the presentation area.

22. The broadcast management unit of claim 21, wherein the providing circuitry is further configured to provide a sending of a message from the base station to the at least one user equipment, which message requests the at least one user equipment to at least one of visually and audially present the digital content in response to that the at least one user equipment has determined that the at least one user equipment is located in the presentation area.

23. The broadcast management unit of claim 22, wherein the message comprises an identifier for identifying the digital content, among other digital contents that are provided by one of broadcast and multicast, as a digital content that is associated with a presentation area.

24. The broadcast management unit of claim 22, wherein the message comprises an identifier identifying the presentation area.

25. The broadcast management unit of claim 22, wherein the message comprises at least one tag that is unique for at least one profile group of user equipments for which profile groups the digital content is relevant to be at least one of visually and audially presented, wherein each profile group comprises user equipments that are associated with at least one of similar user profiles and similar settings.

26. The broadcast management unit of claim 22, wherein the message comprises a service announcement that identifies the digital content and the availability of the digital content in the provided at least one of broadcast and multicast.

27. The broadcast management unit of claim 22, wherein the message is comprised in a data carousel that the providing circuitry is configured to provide by one of broadcast and multicast in the service area.

28. The broadcast management unit of claim 21, wherein the presentation area is a sub-area of the service area.

29. The broadcast management unit of claim 21, wherein the presentation area is defined independent of at least one more cell that the presentation area at least partly covers in the service area.

30. A user equipment for receiving a digital content, the user equipment being configured to be served by a base station in a cellular communications network, the user equipment comprising:
an identifying circuitry, configured to identify that the digital content is available from one of a broadcast multicast in a service area and is associated with a presentation area, which service area comprises the presentation area and the user equipment, and
a receiving port, configured to receive the digital content by one of broadcast and multicast from the base station, thereby enabling the user equipment to at least one of visually and audially present the digital content in response to that the user equipment has determined that the user equipment is located in the presentation area.

31. The user equipment of claim 30, further comprising:
a determining circuitry, configured to determine that the user equipment is located in the presentation area, and
a presenting circuitry, configured to, in response to that the determining circuitry has determined that the user equipment is located in the presentation area, at least one of visually and audially present the digital content.

32. The user equipment of claim 30, wherein the identifying circuitry is further configured to receive, from the base station, a message that requests the user equipment to at least one of visually and present the digital content in response to that the user equipment has determined that the user equipment is located in the presentation area.

33. The user equipment of claim 32, wherein the message comprises an identifier for identifying the digital content, among other digital contents in the provided one of broadcast multicast, as a digital content that is associated with a presentation area.

34. The user equipment of claim 32, wherein the message comprises an identifier identifying the presentation area.

35. The user equipment of claim 32, wherein the message comprises at least one tag that is unique for at least one profile group of user equipments for which profile groups the digital content is relevant to be at least one of visually and audially presented, wherein each profile group comprises user equipments that are associated with at least one of similar user profiles similar settings, and wherein any presenting circuitry of the user equipment is configured to at least one of visually and audially present the digital content in response to that the user equipment has determined that the digital content is relevant for the user equipment based on the tag and at least one of a user profile and setting in the user equipment.

36. The user equipment of claim 32, wherein the message comprises a service announcement that identifies the digital content and the availability of the digital content in the provided broadcast or multicast.

37. The user equipment of claim 32, wherein the message is comprised in a data carousel that is provided by one of broadcast and multicast in the service area.

38. The user equipment of claim 30, wherein the identifying circuitry is further configured to store the received digital content prior to that the user equipment has determined that the user equipment is located in the presentation area, and to find the digital content among stored digital contents.

39. The user equipment of claim 30, wherein the presentation area is a sub-area of the service area.

40. The user equipment of claim 30, wherein the presentation area is defined independent of at least one cell that the presentation area at least partly covers in the service area.
